(19) United States
(12) Patent Application Publication
(10) Pub. No.: US 2025/0199262 A1
(43) Pub. Date: Jun. 19, 2025

(54) FLAME RETARDANT DUCT HAVING EMBEDDED STRENGTH ELEMENTS

(71) Applicant: CORNING RESEARCH & DEVELOPMENT CORPORATION, Corning, NY (US)

(72) Inventors: Gerhard Gernot Merbach, Neustadt bei Coburg (DE); Thomas Meyer, Berlin (DE); Waldemar Stöcklein, Coburg (DE)

(21) Appl. No.: 19/065,408

(22) Filed: Feb. 27, 2025

Related U.S. Application Data
(63) Continuation of application No. PCT/US2023/030912, filed on Aug. 23, 2023.
(60) Provisional application No. 63/403,341, filed on Sep. 2, 2022.

(51) Int. Cl. G02B 6/44; B29C 48/00; B29K 23/00; B29K 105/00; B29K 309/00; B29K 505/00; B29L 23/00

(52) U.S. Cl. CPC G02B 6/4459; B29C 48/022; B29K 2023/06; B29K 2023/083; B29K 2105/0088; B29K 2309/14; B29K 2505/00; B29K 2995/0016; B29L 2023/00

(57) ABSTRACT

Embodiments of the disclosure relate to a duct for an optical fiber cable. The duct includes a tubular wall having an inner surface and an outer surface. The inner surface defines a longitudinal bore. A plurality of strength elements is disposed within the tubular wall. The plurality of strength elements is formed from yarns that are not combustible at a temperature below 900° C. Also disclosed are embodiments of a method of forming such a duct. In the method, a flame retardant polymeric composition is extruded to form the tubular wall, and the plurality of strength elements are embedded in the tubular wall. It is expected that the combination of an optical fiber cable having a flame retardant rating and such a duct will maintain the flame retardant rating when the optical fiber cable is disposed within the longitudinal bore of the duct.

### CROSS-REFERENCE TO RELATED APPLICATIONS

This application is a continuation of International Application No. PCT/US2023/030912, filed Aug. 23, 2023, which claims the benefit of priority of U.S. Provisional Application No. 63/403,34| filed on Sep. 2, 2022, the content of which is relied upon and incorporated herein by reference in its entirety.

### BACKGROUND

The disclosure relates generally to ducts for optical fiber cables and more particularly to a duct that, in combination with a flame retardant optical fiber cable, is configured to pass relevant flame retardant regulations. Buildings may be constructed in a manner that allows for the routing of optical fiber cables within the building. Ducts formed of polymeric materials are often used for this purpose. Recent regulations have been implemented that require a certain level of flame retardant performance for building materials, including optical fiber cables. However, the regulations specific to optical fiber cables do not extend to the ducts in which the optical fiber cables are carried. As such, a compliant optical fiber cable, when run through a conventional duct, may no longer be compliant with such regulations.

### SUMMARY

In one aspect, embodiments of the present disclosure relate to a duct for an optical fiber cable. The duct includes a tubular wall having an inner surface and an outer surface. The inner surface defines a longitudinal bore, and the outer surface defines an outermost surface of the duct. A plurality of strength elements is disposed within the tubular wall between the inner surface and the outer surface. The plurality of strength elements comprises yarns that are not combustible at a temperature below 900° C.

In another aspect, embodiments of the present disclosure relate to a method of forming a duct. In the method, a flame retardant polymeric composition is extruded to form a tubular wall having an inner surface defining a longitudinal bore and an outer surface defining an outermost surface of the duct. A plurality of strength elements is embedded in the tubular wall between the inner surface and the outer surface. The plurality of strength elements comprises yarns that are not combustible at a temperature below 900° C.

In still another aspect, embodiments of the present disclosure relate to a combination of an optical fiber cable having a flame retardant rating as measured according to a particular standard and a duct. The duct includes a tubular wall having an inner surface and an outer surface. The inner surface defines a longitudinal bore, and the outer surface defines an outermost surface of the duct. A plurality of strength elements is disposed within the tubular wall between the inner surface and the outer surface. The optical fiber cable is disposed within the longitudinal bore of the duct, and the combination maintains the flame retardant rating after testing the combination according to the particular standard.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. In the drawings:

FIG. 1 depicts a flame retardant duct with embedded strength elements, according to an exemplary embodiment;

FIG. 2 depicts an optical fiber cable contained within a flame retardant duct, according to an exemplary embodiment;

FIG. 3 depicts a cone calorimeter chamber configured for testing according to EN 50399; and

FIG. 4 depicts a process flow diagram for a method of making a flame retardant duct having embedded strength elements, according to an exemplary embodiment.

### DETAILED DESCRIPTION

Referring generally to the following description and appended figures, various embodiments of an improved flame retardant duct for an optical fiber cable are provided. As will be described more fully below, the duct is made from a flame retardant polymeric material having strength elements, such as basalt yarns, embedded therein. When combined with an optical fiber cable, the combination of the optical fiber cable and the duct are configured to pass various flame retardant performance regulations, such as the European Union's Construction Products Regulation (CPR). Under the CPR, optical fiber cables are tested (e.g., according to EN 50399) and certified (e.g., according to EN 50575) for flame retardant performance based on various classifications (e.g., as defined in EN 13501-6). Even the highest rated optical fiber cables (e.g., class B2ca) may not pass flame retardant testing when installed in conventional ducts. Thus, the presently disclosed duct improves upon the flame retardant performance of conventional ducts. These and other aspects and advantages of the disclosed flame retardant duct will be described herein and in relation to the figures. Such exemplary embodiments are provided by way of illustration and not by way of limitation.

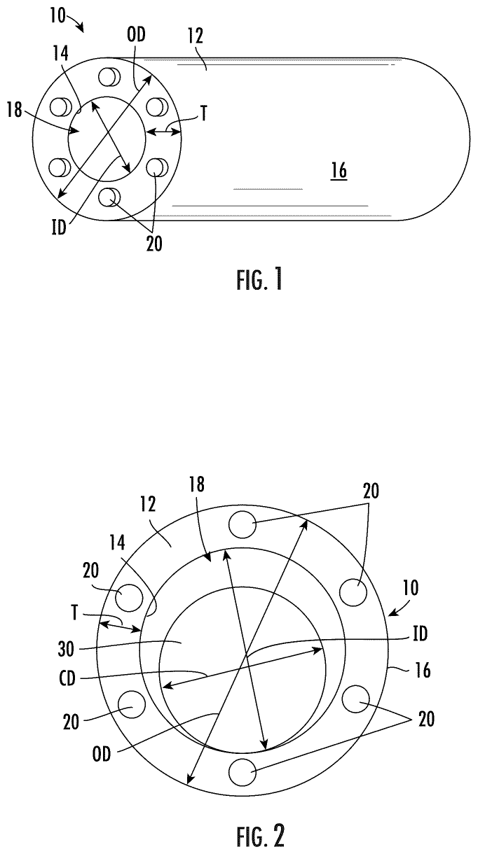

FIG. 1 depicts an exemplary embodiment of a duct 10 for an optical fiber cable. The duct 10 is a tubular wall 12 having an inner surface 14 and an outer surface 16. The inner surface 14 defines a longitudinal bore 18. The outer surface 16 defines an outermost surface of the duct 10. In one or more embodiments, the duct 10 has an outer diameter OD defined by the outer surface 16 and an inner diameter ID defined by the inner surface 14. Further, the distance between the inner surface 14 and the outer surface 16 defines a thickness T of the wall 12. Disposed within the wall 12 between the inner surface 14 and the outer surface 16 are a plurality of strength elements 20.

In one or more embodiments, the wall 12 is made of a flame retardant polymer composition. The flame retardant polymer composition can be any of a variety of suitable flame retardant polymer compositions. In one or more embodiments, the flame retardant material is a highly-filled polymer composition. For example, the highly-filled polymer component may comprise one or a blend of such polymers as ethylene-vinyl acetate copolymers, ethylene-acrylate copolymers, polyethylene homopolymers (low, medium, and high density), linear low density polyethylene, very low density polyethylene, polypropylene homopolymer, polyolefin elastomer copolymer, polyethylene-polypropylene copolymer, butene- and octane-branched copolymers, or maleic anhydride-grafted versions of the foregoing polymers listed above. Other polymers are possible for use in the polymer component of the flame retardant composition, and the foregoing list is merely illustrative.

In one or more embodiments, the highly-filled polymer composition also comprises a flame retardant filler, such as a metal hydroxide. In one or more embodiments, the metal hydroxide is alumina trihydrate (ATH) or magnesium dihydroxide (MDH). In one or more embodiments, the highly-filled polymer composition comprises from 50 wt % to 80 wt % of the flame retardant filler. In one or more embodiments, the balance of the flame retardant polymer composition is one of or a blend of polymers or one of or a blend of polymers and other additives (e.g., colorants, processing or performance aids, compatibilizers, etc.) In one or more embodiments, the highly-filled polymer composition comprises about 60 wt % of ATH/MDH and a blend of polyethylene and ethylene vinyl acetate. An example of commercially available highly-filled flame retardant polymeric composition suitable for use in the duct 10 is CONGuard® 6650 (Condor Compounds GmbH, Braunschweig, Germany).

In one or more embodiments, the strength elements 20 comprise yarns made of materials that are not combustible at temperatures associated with a fire in a premises. In one or more embodiments, the strength elements 20 comprise yarns made from materials that are not combustible at temperatures of at least 900° C., at least 1000° C., or at least 1100° C. (at standard pressure). In one or more embodiments, the strength elements are not combustible at temperatures of up to 1200° C. In one or more embodiments, the strength elements 20 are made from basalt, mineral wool, ceramic fibers, or glass fibers. In one or more preferred embodiments, the strength elements 20 are basalt yarns because of the high non-combustibility temperature and the comparatively low-cost relative to other materials usable for the strength elements 20. In one or more embodiments, the strength elements 20 have a linear density of 500 dtex to 5000 dtex, in particular 1000 dtex to 2000 dtex. In one or more embodiments, the strength elements 20 have a diameter of 0.05 mm to 0.5 mm, in particular 0.1 mm to 0.3 mm. In a particular embodiment, the strength elements were basalt yarns of having a linear density of 1360 dtex and a diameter of about 0.25 mm.

In one or more embodiments, the duct 10 includes at least two strength elements 20 embedded in the tubular wall 12. In order to avoid creating a preferential bend plane, one or more embodiments of the duct 10 include at least three strength elements 20 embedded in the tubular wall 12. In one or more embodiments, the duct 10 includes up to ten strength elements 20 embedded in the tubular wall 12. In one or more embodiments, the strength elements 20 are equidistantly spaced within the tubular wall 12. In one or more embodiments, the strength elements 20 may be placed at irregular intervals within the tubular wall 12.

As shown in FIG. 2, the duct 10 is configured to surround an optical fiber cable 30. The optical fiber cable 30 has an outer cable diameter CD. The cable diameter CD is less than the inner diameter ID of the duct 10. In one or more embodiments, the inner diameter ID of the duct 10 is about 1.5 mm greater than the cable diameter CD. In one or more embodiments, the outer diameter of the duct 10 is from 1 mm to 5 mm greater than the inner diameter ID, in particular from 1.5 mm to 3.5 mm greater than the inner diameter ID. In one or more embodiments, the thickness T of the tubular wall 12 is from 0.5 mm to 2.5 mm. For example, for an optical fiber cable 30 having a cable diameter CD of 2 mm, the duct 10 may have an inner diameter ID of 3.5 mm and an outer diameter of 4.5 mm to 8.5 mm, in particular 5 mm to 7 mm. The difference in diameter between the cable diameter CD and the inner diameter ID may facilitate blowing of the optical fiber cable 30 in the duct 10 and may also avoid creating a chimney effect during a fire, whereby air is pulled into the fire and smoke and heat is able to move up the duct 10 and cable 30.

Recently, regulations regarding the construction of buildings have been put in place that require products be labeled (according to EN 50575) with their level of flame retardancy. Tests have been established to measure flame retardancy, including EN 50399, which specifies a level of flame retardancy for cables, such as optical fiber cables. The flame retardant performance is assigned a classification defined in EN 13501-6. The tests are designed to consider cables, taking into account the structure of cables, and in cables, there are several tensile elements, such as optical fibers, strengthening yarns, and glass-reinforced plastic rods, etc. These tensile elements keep the cable together during combustion. There is no specific test standard for optical fiber cable ducts, and such ducts are often tested by themselves under standards related to construction components. Because conventional ducts do not contain any tensile elements but are instead just extruded polymeric tubes, the response of a duct under flame retardancy testing for components is not necessarily reflective of the actual flame retardant performance of the duct when considering the context of use with optical fiber cables.

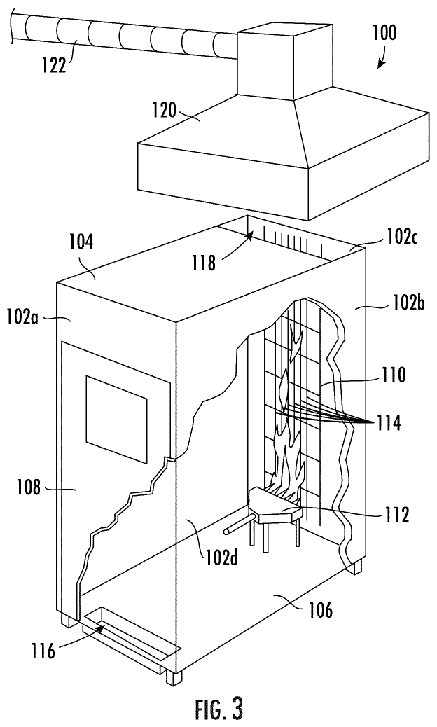

FIG. 3 depicts an example of a cone calorimeter test chamber 100 for determining flame retardancy under EN 50399. The test chamber 100 includes an enclosure having side walls 102a-d, a ceiling 104, and a floor 106. A door 108 having a window may be provided through one of the side walls, such as side wall 102a. Disposed within the enclosure is a sample holder, referred to as a ladder 110. In the embodiment depicted, the ladder 110 is mounted to the side wall 102c opposite to the side wall 102a having the door 108. A flame nozzle 112 is positioned at the bottom of the ladder 110. Samples 114 (such as bundles of cables or cables within ducts) are secured to the ladder 110, and the flame nozzle 112 ignites the bottom of the samples 114. Air is pumped into the enclosure through a lower vent 116 in the floor 106. Smoke generated during combustion is evacuated through an upper vent 118 in the ceiling 104 and is collected in a hood 120 connected to an exhaust pipe 122. As part of the testing under EN 50399 and other relevant flame retardant standards, the smoke may be analyzed using equipment in the exhaust pipe 122 or downstream of the exhaust pipe 122.

Various flame retardancy parameters are measured during testing, such as heat release rate, peak heat release rate, total heat release, acidity of exhaust gas, and flame spread, among others. When a conventional duct is tested, the polymeric material of the duct quickly melts, and the lower portion of the duct drops in large pieces to the bottom of the chamber where it continues to burn. Because the duct melts and falls apart, the duct ostensibly contributes to a low flame spread, but this test result is misleading because duct pieces continue to burn at the bottom of the chamber. Nevertheless, this test result may be recorded and the product may be labeled with the misleading flame retardant certification.

According to embodiments of the present disclosure, the duct 10 includes the strength elements 20 embedded in the tubular wall 12, which provide a tensile structure to hold the duct 10 together during testing. Further, because the more combustible polymeric material of the duct 10 is replaced with a substantially non-combustible material (e.g., basalt yarns), the flame retardant performance of the duct 10 is improved. Based on the improved flame retardant performance of the duct 10, the inventors expect that the rating of a cable 30 contained in a disclosed duct 10 will be maintained during flame retardant testing. For example, if a cable 30 is rated at B2ca according to EN 50575 when tested alone under EN 50399, then the inventors expect that the combination of the cable 30 and the duct 10 will still be rated B2ca when tested according to the cable standard.

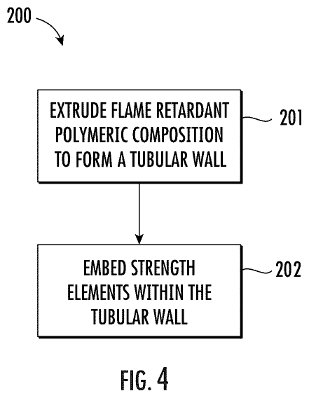

FIG. 4 depicts a process flow diagram of a method 200 of forming a duct 10 (e.g., as shown in FIGS. 1 and 2) according to one or more embodiments of the present disclosure. In a first step 201 of the method 200, a flame retardant polymeric composition is extruded to form a tubular wall 12. In a second step 202, a plurality of strength elements 20 are embedded within the tubular wall 12 between the inner surface 14 and the outer surface 16. In one or more embodiments, the first step 201 and the second step 202 are performed substantially simultaneously in that the strength elements 20 pass through the extrusion die at the same time as the flame retardant polymeric composition is extruded so that the strength elements 20 are embedded into the molten flame retardant polymeric composition. In one or more embodiments, the extruded duct 10 is cooled (e.g., in a water trough) and taken up on a reel.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A duct for an optical fiber cable, comprising:
a tubular wall having an inner surface and an outer surface, the inner surface defining a longitudinal bore and the outer surface defining an outermost surface of the duct;
a plurality of strength elements disposed within the tubular wall between the inner surface and the outer surface;
wherein the plurality of strength elements comprises yarns that are not combustible at a temperature below 900° C.

2. The duct of claim 1, wherein the yarns comprise at least one of basalt, mineral wool, ceramic fibers, or glass fibers.

3. The duct of claim 1, wherein the plurality of strength elements comprises basalt yarns.

4. The duct of claim 1, wherein the yarns have a linear density of 500 dtex to 5000 dtex.

5. The duct of claim 1, wherein the plurality of strength elements comprises at least three strength elements.

6. The duct of claim 5, wherein the at least three strength elements are positioned such that the tubular wall does not have a preferential bend plane.

7. The duct of claim 1, wherein the tubular wall comprises a flame retardant polymeric composition.

8. The duct of claim 7, wherein the flame retardant polymeric composition comprises from 50 wt % to 80 wt % of a flame retardant filler.

9. The duct of claim 8, wherein the flame retardant filler comprises at least one of aluminum trihydrate or magnesium dihydroxide.

10. The duct of claim 7, wherein the flame retardant polymer composition comprises a blend of polyethylene and ethylene vinyl acetate.

11. A method of forming a duct, comprising:
extruding a flame retardant polymeric composition to form a tubular wall having an inner surface defining a longitudinal bore and an outer surface defining an outermost surface of the duct;
embedding a plurality of strength elements in the tubular wall between the inner surface and the outer surface, the plurality of strength elements comprising yarns that are not combustible at a temperature below 900° C.

12. The method of claim 11, wherein the yarns comprise at least one of basalt, mineral wool, ceramic fibers, or glass fibers.

13. The method of claim 11, wherein the plurality of strength elements comprises basalt yarns.

14. The method of claim 11, wherein the yarns comprise a linear density of 500 dtex to 5000 dtex.

15. The method claim 11, wherein the plurality of strength elements comprises at least three strength elements.

16. The method of claim 15, wherein the at least three strength elements are positioned such that the tubular wall does not have a preferential bend plane.

17. The method of claim 11, wherein the flame retardant polymeric composition comprises from 50 wt % to 80 wt % of a flame retardant filler.

18. The method of claim 17, wherein the flame retardant filler comprises at least one of aluminum trihydrate or magnesium dihydroxide.

19. The method of claim 17, wherein the flame retardant polymer composition comprises a blend of polyethylene and ethylene vinyl acetate.

20. A combination, comprising:
an optical fiber cable comprising a flame retardant rating as measured according to a particular standard; and
a duct comprising:
a tubular wall, the tubular wall having an inner surface and an outer surface, the inner surface defining a longitudinal bore and the outer surface defining an outermost surface of the duct; and
a plurality of strength elements, the plurality of strength elements being disposed within the tubular wall between the inner surface and the outer surface;
wherein the optical fiber cable is disposed within the longitudinal bore of the duct; and
wherein the combination maintains the flame retardant rating after testing the combination according to the particular standard.

21. The combination of claim 20, wherein the plurality of strength elements comprises yarns that are not combustible at a temperature below 900° C.

22. The combination of claim 20, wherein the plurality of strength elements comprises basalt yarns.

23. The combination of claim 20, wherein the tubular wall comprises a flame retardant polymeric composition.

24. The combination of claim 23, wherein the flame retardant polymeric composition comprises from 50 wt % to 80 wt % of a flame retardant filler.

25. The combination of claim 20, wherein the flame retardant rating is B2ca according to EN 50575 as measured according to the particular standard of EN 50399.
